(19) United States
(12) Patent Application Publication
(10) Pub. No.: US 2025/0286222 A1
(43) Pub. Date: Sep. 11, 2025

(54) METHOD AND DEVICE FOR THE ADHESIVE BONDING OF LAYERS OF AN ENERGY CELL

(71) Applicant: Körber Technologies GmbH, Hamburg (DE)

(72) Inventors: Nils Hofmann, Otterstedt (DE); Alexander Gansewig, Reinbek (DE); Bernd Timmann, Hamburg (DE); Alexander Gräfe, Barum (DE); Marcus Wagner, Hamburg (DE)

(21) Appl. No.: 18/859,914

(22) PCT Filed: Apr. 18, 2023
(86) PCT No.: PCT/EP2023/059945

§ 371 Date: Oct. 24, 2024

(30) Foreign Application Priority Data
Apr. 27, 2022 (DE) 102022110254.8

(51) Int. Cl. H01M 50/46

(52) U.S. Cl. CPC H01M 50/461

(57) ABSTRACT

A method for producing energy cells in stack form having a plurality of separator sheets and a plurality of electrodes arranged between the separator sheets, wherein the plurality of electrodes are alternately arranged anodes and cathodes. At least one electrode is fixed to at least one of the separator sheets by an adhesive bond. The adhesive composition for the at least one adhesive bond is applied by gravure printing, to provide particularly exact adhesive bonding.

### CROSS-REFERENCE TO RELATED APPLICATIONS

The present application is the National Phase entry of International Patent Application No. PCT/EP2023/059945, filed Apr. 18, 2023, which claims priority to German Patent Application No. 102022110254.8, filed Apr. 27, 2022, the entire contents of both are hereby incorporated by reference into this application.

### FIELD OF THE INVENTION

The present invention relates to a method for producing energy cells in stack form having a plurality of separator sheets and a plurality of electrodes arranged between the separator sheets, namely alternately arranged anodes and cathodes, wherein at least one electrode is fixed to at least one of the separator sheets by means of an adhesive bond, and to an apparatus for producing energy cells in stack form having a plurality of separator sheets and a plurality of electrodes arranged between the separator sheets, namely alternately arranged anodes and cathodes, wherein the separator sheets and electrodes for stack formation are supplied individually or in prefabricated composite units consisting of at least two components, comprising a stacking station in which the stacks of the individual components and the prefabricated composite components are formed, comprising at least one adhesive composition application device which is configured and adapted to apply an adhesive composition to at least one of the supplied components.

### BACKGROUND OF THE INVENTION

Energy cells, or energy storages, within the context of the invention are used, for example, in motor vehicles, other land vehicles, ships, aircraft or also in stationary installations such as, for example, photovoltaic installations in the form of battery cells or fuel cells, in which very large amounts of energy must be stored for relatively long periods of time. For this purpose, such energy cells have a structure comprising a large number of segments stacked to form a stack. These segments are each formed of alternating anode sheets and cathode sheets, which are separated from one another by separator sheets, which are likewise in the form of segments. Various methods are known for producing the stacks. Conventionally, the segments are pre-cut in the production process and are then placed one on top of another in the predetermined sequence separator-anode-separator-cathode to form the stacks and bonded together by lamination. The four-ply stacks thus formed are referred to as a monocell. In another method, the anode sheets and cathode sheets are first cut from an endless web and then placed spaced apart at intervals, in isolated form, on a respective endless web of a separator material. This “two-ply” endless web thus formed, consisting of the separator material with the anode sheets and cathode sheets placed thereon, is then again cut into segments in a second step using a cutting apparatus, wherein the segments are in this case formed in two-ply form by a separator sheet with an anode sheet or cathode sheet arranged thereon. If feasible or required in terms of the manufacturing process, the endless webs of the separator material with the anode sheets and cathode sheets placed thereon can also be placed one on top of another before cutting, so that an endless web having a first endless layer of the separator material with anode sheets or cathode sheets placed thereon and a second endless layer of the separator material, again with anode sheets or cathode sheets placed thereon, is formed. This “four-ply” endless web is then cut into segments by means of a cutting apparatus, whereby monocells are again formed. Fixing of the respective layers or sheets to the layers is conventionally carried out by means of lamination. Fixing is very important, because the segments must be stacked one on top of another very precisely with only low tolerance and must not be displaced relative to one another. The separator sheets must reliably separate the anode and the cathode from one another in order to avoid short circuits. Apparatuses and methods for producing a cell stack for battery cell manufacture are known, for example, from DE 10 2017 216 138 A1 and DE 10 2017 216 213 A1 or DE 10 2018 219 000 A1.

Lamination is an energy-intensive process and the production costs of the lamination unit(s) are very high. In addition, suitable materials must be used for the lamination process. Thus, the separator in particular must be laminable, which greatly limits the choice of possible materials to be used, especially because further requirements (e.g. small layer thickness) must be met.

Alternative possibilities for fixing the layers to one another have therefore been proposed. Thus, it is known from EP 3 588 653 A1 to provide the anode and cathode sheets with an adhesive composition by means of adhesive nozzles and thus produce webs with electrodes adhesively bonded thereto, from which monocells can in turn be cut.

The application of the adhesive composition from the nozzles is problematic. Specifically when the adhesive composition is applied transverse to the running direction of the web, it is difficult to apply the adhesive composition cleanly. In particular the low viscosity of the adhesive compositions used renders a precise application more difficult. The process is difficult to control, because the web has to be drawn over a stationary nozzle with a given web tension. It would therefore be desirable to provide an apparatus and a method which allow for the adhesive composition being applied without the use of nozzles.

A further problem arises during further processing, namely when a plurality of these monocells are to be joined together by stacking to form the final energy cells. The stacked monocells must also be fixed to one another in order to prevent slipping. In the prior art, this is carried out either by means of lamination. Alternatively, the stack is fixed using adhesive tape and optionally subsequently guided through a “hot press” and laminated in a follow-up process. The problem here is that a stack is produced without being fixed directly. Monocells are produced by means of lamination and/or adhesive bonding and are joined together to form an inhomogeneous stack. In some cases, attempts are later made to bond (homogenise) the stack as a whole.

### SUMMARY OF THE INVENTION

Accordingly, the object of the present invention was to provide a method and an apparatus which create homogeneous energy cells, ensure secure fixing of the individual layers to one another, which also outlast follow-up processes such as cutting, and permit secure fixing in the desired position and thereby ensure clean, exact application of adhesive composition.

This object is achieved in that, in a method of the type mentioned at the beginning, the adhesive composition for the at least one adhesive bond is applied by gravure printing and in that, in an apparatus of the type mentioned at the beginning, the at least one adhesive composition application device is a gravure printing roller.

Such a gravure printing roller has on its lateral surface recesses for picking up and transporting adhesive composition, wherein the recesses produce a corresponding adhesive pattern on the layer to be provided with adhesive composition. Different recesses can have the same or a different recess volume per unit area.

It is thus possible to place pin-sharp individual or multiple adhesive dots or any other adhesive composition pattern on the electrode or in particular on the separator. Very good fixing of electrodes and separators is thus ensured.

It is possible that the adhesive composition is applied by means of a gravure printing roller only for some of the adhesive bonds that are to be produced, while the adhesive composition for other adhesive bonds is applied, for example, by means of a nozzle. It is particularly advantageous, however, if all the required applications of adhesive composition are carried out by the gravure printing method.

In a particularly advantageous manner, anodes are supplied on a conveying path A, cathodes are supplied on a conveying path B and separator sheets in the form of separator webs are each supplied on a conveying path C and D, endless webs with cut cathode and anode sections are first formed from the two separator webs and the anodes and the cathodes, wherein all the bonds between the separators and the electrodes are formed by means of adhesive bonding, and in a further step the endless webs are separated into individual monocells. The production speed can thus be increased and there is the advantage that individual products can be tested for quality in the continuous region.

The object is further achieved in that, in a method of the type mentioned at the beginning, the energy cells in stack form are formed by stacking a plurality of monocells, wherein the monocells are fixed to one another by means of adhesive bonding or-in the case where the energy cells are produced not via the intermediate step of forming monocells but by alternate stacking of the desired number of electrodes and separators-in that the application of adhesive is carried out immediately before the stack formation of the energy cells in stack form by the alternate stacking of separator sheets and electrodes.

“Immediately before the stack formation” means in particular that the application of adhesive to the electrode/separator sections is carried out when said sections are on the accelerator roller. Ideally, the application of adhesive is carried out on the accelerator roller because the products here have the correct orientation and the speed can be adjusted if required. At certain positions of the accelerator roller, the products are at a standstill or at a constant speed, while at other positions they are accelerated. The expression “immediately before stacking” also includes an alternative form. That is, alternatively, the adhesive composition can be applied during discharge onto the stack. Advantageously, this can be carried out by the discharge lever or, after discharge, by an additional moving element.

Finally, the object is achieved by an apparatus of the type mentioned at the beginning, which has a monocell stacking device for stacking a plurality of monocells to form the energy cells in stack form, wherein an adhesive composition application device is associated with the stacking device or-again in the case where the energy cells are produced not via the intermediate step of forming monocells but by alternate stacking of the desired number of electrodes and separators-which has a stacking device for forming energy cells in stack form by alternately stacking separator sheets and electrodes, an adhesive composition application device being associated with said stacking device.

Application of the adhesive composition is thus here carried out directly at the stacking wheel, that is to say directly during the stacking process. By means of this inline adhesive bonding process, fixing can be integrated into the production process failure-free. Fixing by adhesive bonding is carried out directly during stacking of the individual layers or of the monocells one on top of another, so that no process steps have to be bridged, or no period of time during the method has to be coped with, in which the stacks are in a form in which they are stacked but are not yet fixed to one another. The quality of stacking is thus improved in a relevant manner and the reliability of the energy cells that are produced is increased significantly.

Particularly advantageously, application of the adhesive is carried out in this process by means of the gravure printing using a gravure printing roller. As described above, a particularly good and exact application of the adhesive composition in the desired pattern is thus possible.

Particular preference is given to the use of an adhesive composition which has a melting point above 20° C., in particular above 30° C. Such an adhesive composition is solid at the usual process temperatures and thus ensures immediate firm fixing. It is heated prior to application. The adhesive composition application device therefore advantageously has a settable and adjustable heater for the adhesive composition. “Melting point” is here to be understood as meaning the melting point of the adhesive composition if it is a material that has a clearly determinable melting point. Many polymeric adhesive compositions do not have a clear melting point, however, but instead have a melting range. In the case of a melting range, “melting point” means the lower limit of the melting range.

The upper limit of the melting point is determined by the melting point of the separator material. The melting point of the adhesive composition (in the case of a melting range, the upper limit of the melting range) should always be below the melting point of the separator material. Preferably, the melting point of the adhesive composition is therefore not more than 100° C., preferably not more than 80° C. and particularly preferably not more than 50° C.

The adhesive composition application device can apply the adhesive composition continuously or intermittently.

In a very particularly advantageous embodiment, the adhesive composition is soluble in the electrolyte used for the energy cell. The adhesive composition is in this case not a foreign body on the electrode which, as it were, “passivates” part of the electrode, that is to say the entire electrode surface is available for energy generation, because the electrically active surface is not reduced. It is thus also irrelevant which part of the electrode surface is covered with adhesive composition. If the adhesive composition does not dissolve in the electrolyte, it is particularly advantageous for only as small an area as possible of the electrode to be provided with adhesive composition. The minimal application for a required fixing strength will thus always be chosen. If, on the other hand, the adhesive composition is soluble in the electrolyte, the limitation of as small an adhesive composition application as possible ceases to apply, and it is not necessary to work with as small an adhesive composition application as possible. Instead, fixing can be improved by a larger amount of adhesive composition without the fear of losses in terms of the capacity of the energy cell.

Preferably, the adhesive composition is heated immediately before it is applied. For this purpose, a settable and adjustable heater is associated with the adhesive composition application system, in particular with the adhesive composition reservoir of the gravure printing roller.

Solidification of the adhesive composition and thus bonding of the materials to be adhesively bonded results from cooling the adhesive composition to below its melting point. It is therefore further preferred for the adhesive composition to be cooled to below its melting point after it has been applied, cooling being carried out actively or passively. Depending on the melting point of the adhesive composition, sufficient cooling of the adhesive composition resulting in solidification can be carried out passively by virtue of free convection simply by means of a sufficiently long cooling section. If more rapid solidification of the adhesive composition is desired, active cooling of the adhesive composition can also be carried out. For this purpose, the apparatus has a cooling device for actively cooling the applied adhesive composition. The cooling device advantageously has control means by means of which the cooling process can be controlled.

There are many possibilities for applying the adhesive composition. Application over the entire surface is possible. This is preferred if, as described above, the adhesive composition dissolves in the electrolyte. The adhesive composition can then be applied over the entire surface without the performance of the energy cell being affected. In a further preferred embodiment, the adhesive composition is applied to part of the surface of the electrode and/or of the separator. Further possibilities are application of the adhesive composition in the form of strips or dots. Particular preference is given to the application of individual dots in the four corners of the electrode sheet to be adhesively bonded or at the corresponding locations on the separator. Particularly preferably, the smallest possible amount of adhesive composition is applied, since this is particularly material-saving.

Application of the adhesive composition to the web material can be carried out in different ways:

In a preferred embodiment, the adhesive composition is applied continuously or intermittently to the separator film, whereupon the electrodes are applied and fixed. Fixing is effected in particular by cooling and thus solidifying the adhesive composition. In another preferred embodiment, the adhesive composition is applied continuously or intermittently to the electrode web (anode web and cathode web) and combined with the separator. In a third preferred embodiment, the adhesive composition is applied continuously or intermittently to the electrode sections, which are then combined with the separator.

Advantageously, the apparatus according to the invention has control means for controlling the application of the adhesive composition. The control means can control in particular the application temperature and/or application amount of the adhesive composition. Important parameters for the control are in particular the thermal capacity, the thermal conductivity, the web speed of the anode, cathode and separator webs and also the length of the cooling section and the cooling power.

Particularly preferably, the adhesive bonding is followed by a step of pressing the adhesively bonded materials together, in which the adhesively bonded materials are bonded together even more strongly. For this purpose, the apparatus according to the invention preferably has means for pressing the adhesively bonded materials together. Such pressing together can be carried out contactlessly. Preferably, this can take place by adjusting the web tension of the endless web of the separator or via a directed air stream. In a preferred embodiment, the apparatus according to the invention therefore further has control means for adjusting the web tension of the separator web and/or means for introducing an air stream, which are arranged downstream of the adhesive composition application device in the process sequence and at the location at which the respective materials are joined together. In a further preferred embodiment, the means for pressing the adhesively bonded materials together are in contacting form, in particular in the form of laminating rolls, preferably of rubber, which press the adhesively bonded materials together with a defined force, or in the form of soft brushes with which a contact pressure is produced.

In a further advantageous embodiment, application is carried out by means of a transfer device, which in particular can be in the form of a transfer roller. This method is used especially when electrode and/or separator sections are to be provided with adhesive. A transfer device can also be used when applying adhesive to material in web form, but this is not necessarily required. Instead, application can in this case be carried out directly via the gravure printing roller.

If the energy cells are produced by first forming monocells and then stacking them to form the energy cells, it is particularly advantageous for all the bonds between layers, that is to say both the layers in the monocells and the bonding of the monocells to one another, to be carried out by means of adhesive bonding. Homogeneous bonding is thus ensured. Particularly advantageously, an adhesive composition which dissolves in the electrolyte of the energy cell is used here.

With the present invention it is possible to produce an energy cell without the need for lamination. If all the required bonds of the layers to one another are carried out by means of adhesive bonding, lamination can thus be dispensed with completely. Such a “lamination-free” method is particularly preferred because it is in particular more energy-efficient and additionally ensures homogeneous bonding of all the layers to one another. Furthermore, the lamination-free method according to the invention opens up greater variability in terms of the separator materials, which are no longer required to be laminable. According to the invention, materials that have good wettability are particularly preferably used as the separator, ceramic-coated separators being particularly preferred here.

Adhesive compositions to be considered are in principle all solvent-free and non-aqueous adhesive compositions which have a melting point above 20° C. In a very particularly preferred embodiment, there is used as the adhesive composition at least one compound from the group consisting of acrylates, methacrylates, SBS block copolymers, SIS block copolymers, polyurethanes, silicones, natural rubbers, synthetic rubbers, epoxy resins, polyolefin resins and ethylene carbonate. In particular, the adhesive composition can be a pressure-sensitive adhesive composition. Ethylene carbonate is a cyclic ester with a melting point of 36° C. Ethylene carbonate is a common solvent and is used as the electrolyte in lithium-ion batteries. Owing to its melting point, it is particularly suitable as an adhesive composition for the present application.

Dependent claims are directed to the mentioned and other expedient and advantageous embodiments of the invention. Only particularly expedient and advantageous embodiments and embodiment possibilities are described in greater detail with reference to the following description of the exemplary embodiments shown in the schematic drawing. Any individual or detailed form described within an exemplary embodiment is to be understood as being a structurally independent detailed example of other embodiments and forms which are not described or not fully described and which fall within the scope of the invention.

### BRIEF DESCRIPTION OF THE DRAWINGS

In the figures

FIG. 1 shows a detail of a stacking station having two stacking devices with application of adhesive composition; and

FIG. 2 shows an embodiment of a monocell production device with application of adhesive composition to the separator.

### DETAILED DESCRIPTION OF THE INVENTION

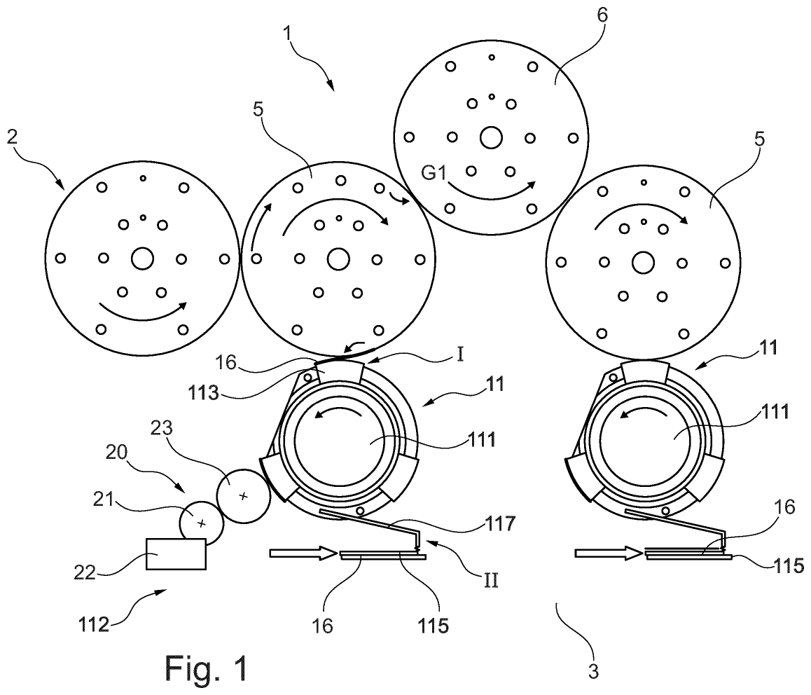

FIG. 1 shows a detail of a stacking station 1 having two stacking devices having an adhesive composition application device 20, a supply device 2, two transfer drums 5 and a reversing drum 6 arranged between the transfer drums 5. The stacking station further comprises two cell stacking apparatuses 11 each having a removal apparatus 111 and an associated discharge element 112. The removal apparatus 111 is configured as a rotating body in the form of a drum, which is driven in a rotating movement, and has three take-off dies 113 oriented at angles of 120 degrees relative to one another. The take-off dies 113 have an outer surface which corresponds in its external dimensions at least to the outer form of the segments 16 or may even be larger than the segments. The take-over dies 113 have, in their cross section perpendicularly through the rotational axis of the removal apparatus 111, an outer contour having the shape of a circular arc section with in each case equal radii, so that they complement one another to form a virtual circle. The removal apparatuses 111 with their take-over dies 113 are further so arranged and so dimensioned in terms of their radii that, during the rotational movement, they touch, with the outer surfaces of the take-over dies 113, the lateral surfaces of the transfer drums 5 with a gap corresponding at least to the thickness of the segments 16. The rotational movement of the removal apparatus 111 is so controlled relative to the respective transfer drum 5 that the take-over dies 113 each take exactly one segment 16 from the transfer drum 5 during the revolution. For this purpose, the movement of the removal apparatus 111 is so controlled that the lateral surfaces of the take-over dies 113, at the point of the shortest distance from the transfer drum 5, which corresponds to the take-over point I, have a circumferential speed corresponding to the circumferential speed of the segments 16 held on the transfer drum 5, and in an ideal case the segments 16 are taken by the take-over dies 113 without a relative speed in the circumferential direction.

Vacuum lines are provided in the webs of the take-over dies 113, which vacuum lines can be supplied with negative pressure and which open with their openings into the front-end lateral surfaces of the webs and/or take-over dies 113. Furthermore, corresponding openings of vacuum lines which can be supplied with negative pressure can also be provided in the lateral surfaces of the transfer drums 5. The segments 16 are then held against the lateral surfaces of the transfer drums 5 by the application of negative pressure in the vacuum lines and are taken on from the removal apparatus 111 by switching off the negative pressure in the vacuum lines of the transfer drums 5 and by switching on the negative pressure in the vacuum lines of the take-over die 113 passing through the take-over point I.

Individual separator sheets or monocells having separator sheets considered as segments 16. In the case where the segments are monocells, the stacking device is a monocell stacking device.

The revolving movement of the removal apparatuses 111 and thus of the take-over dies 113 is so controlled that they take the segments 16 from the transfer drums 5 in a predetermined sequence. In the present exemplary embodiment, two cell stacking apparatuses 11 are provided, so that each of the cell stacking apparatuses 11 takes segments 16 from the supply device 2 in a fixed sequence in a double rhythm. Thus, in a revolution, the first removal apparatus 111, associated with the first transfer drum 5, of the first cell stacking apparatus 11 takes the first segments 13 of a pair from the first transfer drum 5 with one of its take-over dies 113 in a rhythm. The segments 16 of the pairs that have remained on the first transfer drum 5 are then taken by the first reversal drum 6 and further transferred to the second transfer drum 5. In the same manner, the second cell stacking apparatus 11 then removes the second segments 16 of the pairs from the second transfer drum 5 with the take-over dies 113 of the second removal apparatus 111. Since each of the removal apparatuses 111 has three take-over dies 113, the segments 16 are removed from the supply by the take-over dies 113 in three pairs, until all the segments 16, after being transferred, have been removed by the second transfer drum 5.

The removal apparatuses 111 are each arranged between a transfer drum 5 and a discharge element 112 and take on the segments 16 from the transfer drum 5 according to the sequence described above. The removal apparatuses 111 are driven in a rotational movement counter-clockwise, as can also be seen from the direction of the arrows in FIG. 1. While one of the segments 16 is being taken on from a transfer drum 5, one of the take-over dies 113 of the removal apparatus 111 is in the “12 o'clock position” and passes through the take-over point I. This position of the removal apparatus 111 with a take-over die 113 arranged in the “12 o'clock position” is also referred to within the context of the invention as the take-over position of the removal apparatus 111. In this position, the take-over die 113 that has taken on the segment 16 of the preceding group of four from the removal drum 5 is in the “8 o'clock position”. In this take-over position, the removal apparatus 111 rotates with a circumferential speed of the lateral surfaces of the take-over dies 113 which corresponds to the circumferential speed of the segments 16 on the transfer drum 5 and takes on precisely one segment 16 with the transfer die 113 arranged in the “12 o'clock position”. A further take-over die 113 is in the “4 o'clock position” and is not carrying a segment 16, that is to say has an empty lateral surface, because it has just handed over a segment 16 to the discharge element 112.

The adhesive composition application device 20 is also provided in the “8 o'clock position”. In the embodiment of FIG. 1, the adhesive composition application device consists of the gravure printing roller 21, the adhesive composition storage container 22 and the transfer roller 23. The adhesive composition in the adhesive composition storage container 22 is heated to 40° C. and thus liquefied by a heating device (not shown). The gravure printing roller 21 has recesses in the form of wells in order to produce the desired adhesive composition pattern on the segment 16. The heated adhesive composition passes from the adhesive composition storage container 22 into the corresponding wells of the gravure printing roller 21. These wells supply the adhesive composition to the transfer roller 23 in the given adhesive composition pattern. The transfer roller 23 is synchronised with the removal apparatus 111 in such a way that the transfer roller 23 has the same speed as the removal apparatus 111 in the “8 o'clock position”. In this manner, the adhesive pattern can be transferred in the “8 o'clock position” from the transfer roller 23 to the segment 16.

In order to hand over the segment 16 from the take-over die 113 that is in the “8 o'clock position” in the take-over position of the removal apparatus 111, the removal apparatus 111 rotates further until the removal apparatus 111 is arranged with the take-over die 113 previously arranged in the “8 o'clock position” in the “6 o'clock position” and passes through the hand-over point II. Application of the adhesive composition in the “8 o'clock position” thus takes place immediately before the stack formation, which follows the hand-over point II.

The hand-over point II is the point at which the distance between the lateral surface of the transferring take-over die 113 and of the discharge element 112 is the smallest. Because the number of take-over dies 113 is odd, the hand-over point Il can be arranged in the “6 o'clock position” opposite the take-over point I in the “12 o'clock position” without two of the take-over dies 113 simultaneously passing the take-over point I and the hand-over point II. The position of the removal apparatus 111 with the take-over die 113 arranged in the “6 o'clock position” is also referred to within the context of the invention as the transfer position of the removal apparatus 111.

During this rotational movement, the removal apparatus 111 can be slowed down to such an extent that the removal apparatus rotates at a lower circumferential speed in the take-over position, in order to facilitate hand-over of the segment 16. In the transfer position of the removal apparatus 111, the segment 16 is delivered from the take-over die 113 arranged in the “6 o'clock position” to the discharge element 112.

The discharge element 112 has a holder 115 and also a scraper 117 with a comb-like structure having a plurality of webs which are oriented parallel to one another and which are so dimensioned in terms of width and arrangement that, as the removal apparatus 111 rotates, they engage, owing to their position or by means of an active movement, into the gaps between the webs of the take-over dies 113 of the removal apparatus 111 and comb the segment 16 held thereon from the take-over die 113, in the transfer position II, passively and/or actively by their own movement and/or by the movement of the removal apparatus 111. The cell stack is thus formed on the holder 115, from where it is transported further and supplied to finishing of the energy cell.

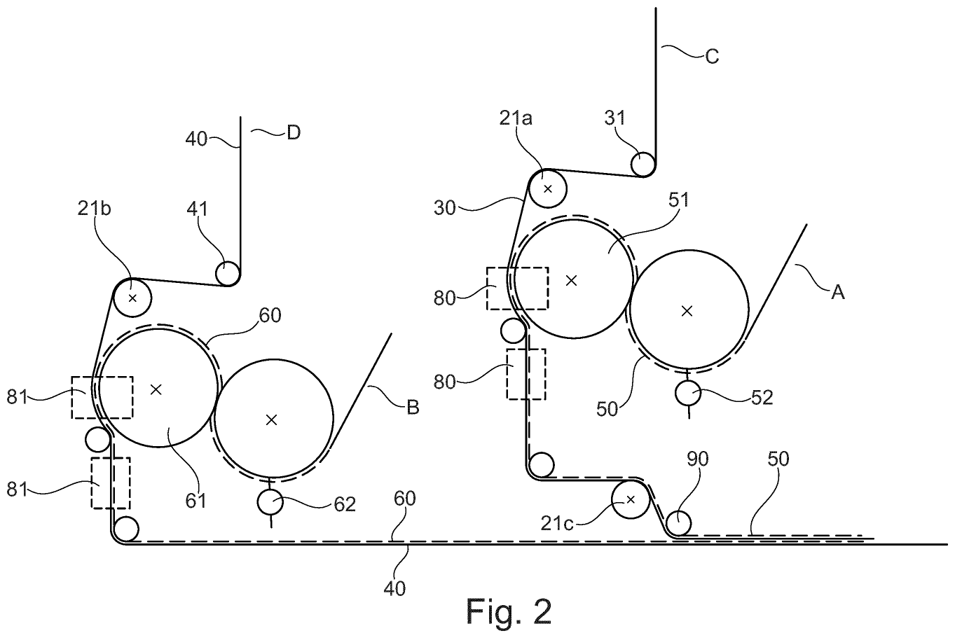

FIG. 2 shows an embodiment of a monocell production device with application of adhesive to the separator. Anodes are supplied on a conveying path A, cathodes are supplied on a conveying path B and separator sheets in the form of separator webs are supplied on a conveying path C and D, respectively. Endless webs with cut cathode and anode sections are first formed from the anodes and the cathodes.

Separator web 30 is supplied on a conveying path C and guided around deflecting roll 31. Adhesive composition heated and thus liquefied by the adhesive composition application device 21a in the form of a gravure printing roller is applied to a first surface of the separator web 30. The gravure printing roller 21a has recesses in the form of wells, which are arranged in a pattern which corresponds to the desired adhesive composition pattern. The adhesive composition is applied to the separator web 30 by the gravure printing roller 21a in the desired adhesive composition pattern in repeating sections.

The anode, which is separated into anode sections 50 by means of a cutting drum 52, is supplied on a conveying path A. The anode sections 50 are supplied to the separator web 30 via an anode dispensing roller 51 and are arranged on the separator web in accordance with the adhesive composition pattern. Via control means (not shown), the gravure printing roller 21a is synchronised with the anode conveying path A so that the anode sections 50 are arranged on the separator web 30 at the desired locations provided with adhesive composition. When the anode sections have been applied to the separator web 30 provided with adhesive composition, the separator web passes through a cooling device 80 in which the adhesive composition is cooled and solidified so that the anode sections 50 are fixed on the separator web 30.

In an analogous manner, separator web 40 is supplied on a conveying path D and guided around deflecting roller 41. Adhesive composition heated and thus liquefied by the adhesive composition application device 21b in the form of a gravure printing roller is applied to a first surface of the separator web 40. This adhesive composition is the same adhesive composition as is also applied to the separator web 30. The gravure printing roller 21b has recesses in the form of wells, which are arranged in a pattern which corresponds to the desired adhesive composition pattern. This adhesive composition pattern can be the same as for the separator web 30, but it may also be different therefrom. The adhesive composition is applied to the separator web 40 by the gravure printing roller 21b in the desired adhesive composition pattern in repeating sections.

The cathode, which is separated into cathode sections 60 by means of a cutting drum 62, is supplied on a conveying path B. The cathode sections 60 are supplied via a cathode dispensing roller 61 to the separator web 40 and are arranged on the separator web in accordance with the adhesive composition pattern. Via control means (not shown), the gravure printing roller 21b is synchronised with the cathode conveying path B so that the cathode sections 60 are arranged on the separator web 40 at the desired locations provided with adhesive composition. When the cathode sections have been applied to the separator web 40 provided with adhesive composition, the separator web passes through a cooling device 81 in which the adhesive composition is cooled and solidified so that the cathode sections 60 are fixed on the separator web 40.

In the further course of the separator web 30 there is a further adhesive composition application device 21c in the form of a gravure printing roller, which again applies heated and liquefied adhesive composition, namely to the second surface of the separator web 30. The two separator webs, the separator web 40 with cathode sections 60 and the separator web 30 with anode sections 50, come together at the pressure roller 90. The separator web 30 is placed with its second surface provided with adhesive composition on the surface of the cathode sections 60 located on the second separator web 40, namely in such a manner that the anode and cathode sections 50, 60 lie with their centres one on top of another. The separator web 30 is fixed to the cathode sections by the adhesive composition, and a monocell web consisting of the two separator webs 30, 40, the anode sections 50 and the cathode 5 sections 60 is formed. The monocell web is cut into the finished monocells by a cutting device (not shown).

1-27. (canceled)

28. A method for producing energy cells in stack form having a plurality of separator sheets and a plurality of electrodes arranged between the separator sheets, namely alternately arranged anodes and cathodes, comprising:
fixing at least one electrode to at least one of the separator sheets by an adhesive bond;
wherein the adhesive composition for the at least one adhesive bond is applied by gravure printing.

29. The method according to claim 28, wherein:
anodes are supplied on a conveying path A:
cathodes are supplied on a conveying path B; and
separator sheets in the form of separator webs are supplied on a conveying path C and D. respectively:
endless webs with cut cathode and anode sections are first formed from the two separator webs and the anodes and the cathodes, wherein all the bonds between the separators and the electrodes are formed by means of adhesive bonding, and in a further step the endless webs are separated into individual monocells.

30. The method according to claim 28, wherein the energy cells in stack form are formed by stacking a plurality of monocells, and said monocells are fixed by adhesive bonding.

31. The method according to claim 28, wherein the energy cells in stack form are formed by alternately stacking separator sheets and electrodes, wherein the application of adhesive is carried out immediately before the stack formation.

32. The method according to claim 28, wherein the adhesive composition has a melting point ranging from over 20° C. to 30° C., or above 30° C.

33. The method according to claim 28, wherein the adhesive composition is soluble in an electrolyte used for the energy cells.

34. The method according to claim 28, wherein the adhesive composition is heated immediately before it is applied.

35. The method according to claim 34, wherein the adhesive composition is cooled after it has been applied, and cooling is carried out actively or passively.

36. The method according to claim 28, wherein a transfer roller applies the adhesive composition.

37. The method according to claim 28, wherein the adhesive composition is applied to either a surface of the separator sheets, a surface of the electrodes, or both surfaces, wherein the adhesive composition is applied over the entirety of a surface, or over a portion of the surface, or in the form of dots.

38. The method according to claim 28, wherein the adhesive bonding is followed by pressing the adhesively bonded materials together.

39. The method according to claim 28, wherein the production of the energy cells in stack form is conducted in a lamination-free manner.

40. The method according to claim 28, wherein the adhesive composition comprises at least one compound from the group consisting of acrylates, methacrylates, SBS block copolymers, SIS block copolymers, polyurethanes, silicones, natural rubbers, synthetic rubbers, epoxy resins, polyolefin resins and ethylene carbonate.

41. An apparatus for producing energy cells in stack form having a plurality of separator sheets and a plurality of electrodes arranged between the separator sheets, wherein the plurality of electrodes comprise alternately arranged anodes and cathodes, wherein:
the separator sheets and electrodes for stack formation are supplied individually or in prefabricated composite units consisting of at least two components;
the apparatus comprising:
a stacking station in which the stacks of the individual components and the prefabricated composite units are formed;
the stacking station comprising at least one adhesive composition application device that is configured and adapted to apply adhesive composition to at least one of the supplied components;
wherein the at least one adhesive composition application device is a gravure printing roller.

42. The apparatus according to claim 41, wherein:
the apparatus has a conveying path A for anodes, a conveying path B for cathodes and a conveying path C and D, respectively, for separator webs, and further has an anode positioning device, which places the anodes on one separator web to produce an anode-separator composite unit, and a cathode positioning device, which places the cathodes on the other separator web to produce a cathode-separator composite unit; and
at least one of the anode positioning device and the cathode positioning device are disposed with an adhesive composition application device for applying adhesive composition to either the electrodes, to the separator, or both the electrodes and the separator.

43. The apparatus according to claim 42, further comprising a monocell production device for producing monocells from the anode-separator and cathode-separator composite units, wherein the monocell production device has an adhesive composition application device that comprises a gravure printing roller.

44. An apparatus for producing energy cells in stack form having a plurality of separator sheets and a plurality of electrodes arranged between the separator sheets, wherein the plurality of electrodes comprise alternately arranged anodes and cathodes, wherein:
the separator sheets and electrodes for stack formation are supplied individually or in prefabricated composite units consisting of at least two components;
the apparatus comprising:
a stacking station in which the stacks of the individual components and the prefabricated composite units are formed;
the stacking station comprising at least one adhesive composition application device which is configured and adapted to apply adhesive composition to either at least one of the electrodes, to the separator, or at least one of the electrodes and the separator, wherein the apparatus has a monocell stacking device for stacking a plurality of monocells to form the energy cells in stack form, wherein the adhesive composition application device is associated with the monocell stacking device.

45. An apparatus for producing energy cells in stack form having a plurality of separator sheets and a plurality of electrodes arranged between the separator sheets, wherein the plurality of electrodes comprise alternately arranged anodes and cathodes, wherein:
the separator sheets and electrodes for stack formation are supplied individually or in prefabricated composite units consisting of at least two components;
comprising a stacking station in which the stacks of the individual components and the prefabricated composite units are formed;
the stacking station comprising at least one adhesive composition application device that is configured and adapted to apply an adhesive composition to either at least one of the electrodes, to the separator, or both the electrodes and the separator, wherein the apparatus comprises the adhesive composition application device coupled with the monocell stacking device as in claim 44.

46. The apparatus according to claim 44, wherein the adhesive composition application device is coupled with the monocell stacking device or wherein the monocell stacking device is a gravure printing roller.

47. The apparatus according to claim 44, wherein the monocell stacking device further comprises an accelerator drum, and the adhesive composition application device is coupled with the accelerator drum.

48. The apparatus according to claim 42, further comprising one or more transfer rollers that are coupled with the gravure printing rollers.

49. The apparatus according to claim 42, further comprising a cooling device for cooling the applied adhesive composition.

50. The apparatus according to claim 49, further comprising one or more controllers for the cooling device.

51. The apparatus according to claim 49, further comprising a heating device for heating and liquefying the cooled adhesive composition.

52. The apparatus according to claim 49, further comprising one or more controllers for the heating device.

53. The apparatus according to claim 42, further comprising one or more controllers for the regulating the adhesive composition application.

54. The apparatus according to claim 42, further comprising one or more controllers for pressing the adhesively bonded materials together.
